(19) United States
(12) Patent Application Publication
(10) Pub. No.: US 2004/0249695 A1
(43) Pub. Date: Dec. 9, 2004

(54) Business task manager

(75) Inventors: Larry Wayne Clark, San Antonio, TX (US); Olvin Brett Lewis, New Braunfels, TX (US)

Correspondence Address: William B. Nash, JACKSON WALKER L.L.P., Suite 2100, 112 E. Pecan Street, San Antonio, TX, 78205, US

(73) Assignee: United Services Automobile Association (USAA)

(21) Appl. No.: 10/858,698

(22) Filed: Jun. 2, 2004

Related U.S. Application Data
(60) Provisional application No. 60/475,523, filed on Jun. 3, 2003.

(51) Int. Cl. G06F 17/60

(52) U.S. Cl. 705/9

(57) ABSTRACT

Accordingly, the present invention provides a system and method capable of managing business process execution in a flexible and cost effective manner. In one embodiment, the present invention utilizes a plurality of externalized process flow rules capable of defining which tasks will be executed and in what order. The process flow rules of the present invention are designed to utilize contextual data in order to statically or dynamically alter the tasks to be executed and/or the order of task execution associated with any given business process. The present invention provides a User Interface (UI) for displaying stored presentation information associated with each task. In one embodiment, the UI provides at least one interface screen through which users may 1) provide the system with contextual data and/or 2) alter task execution flow. The UI may be also equipped with one or more taskbars capable of displaying interactive task execution information.

This utility application claims priority on a United States provisional application entitled “Business Task Manager,” Ser. No. 60/475,523, having a filing date of Jun. 3, 2003.

### FIELD OF THE INVENTION

The present invention relates generally to task flow management and, more particularly, to a method of managing complex process flow arrangements in an electronic environment.

### BACKGROUND OF THE INVENTION

Complex business processes typically require the execution of a great deal of individual tasks. Depending upon the requirements and applicability of each task, the number of tasks to be executed for any given business process may vary. This is especially true regarding online business processes.

Rules or guidelines may be utilized in order to manage which tasks are to be executed and in what order. Known hard-coding techniques provide structure for business process execution but are exceptionally rigid in their design. As such, hard-coded process rules do not allow for flexibility in that they must be re-coded each time an alteration of the business process is required. Such changes are often expensive and subject to programming errors.

There remains a need for a system and method capable of managing complex business processes without the disadvantages associated with known hard-coding techniques.

### SUMMARY OF INVENTION

Accordingly, the present invention provides a system and method capable of managing business process execution in a flexible and cost effective manner. In one embodiment, the present invention utilizes a plurality of externalized process flow rules capable of defining which tasks will be executed and in what order. The process flow rules of the present invention are designed to utilize contextual data in order to statically or dynamically alter the tasks to be executed and/or the order of task execution associated with any given business process.

The present invention provides a User Interface (UI) for displaying stored presentation information associated with each task. In one embodiment, the UI provides at least one interface window through which electronic data corresponding to one or more business tasks may be captured and/or displayed. Through the interface window, the user may 1) provide the system with contextual data and/or 2) alter the task execution flow. This feature of the present invention provides the user with unparalleled flexibility during business process execution. The UI may be also equipped with one or more taskbars capable of displaying and receiving interactive task execution information.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing; it being understood that the drawings contained herein are not necessarily drawn to scale; wherein:

FIG. 1 is a component diagram illustrating one embodiment of the present invention.

FIGS. 2 and 3 are process flow diagrams illustrating the task execution process of one embodiment of the present invention.

FIG. 4 is a screen shot illustrating the user interface of one embodiment of the present invention.

FIG. 5 is a process flow diagram illustrating the contextual data utilization process of one embodiment of the present invention.

### DETAILED DESCRIPTION OF THE INVENTION

The present invention is herein described as a system and method of managing the operation of one or more electronic business processes.

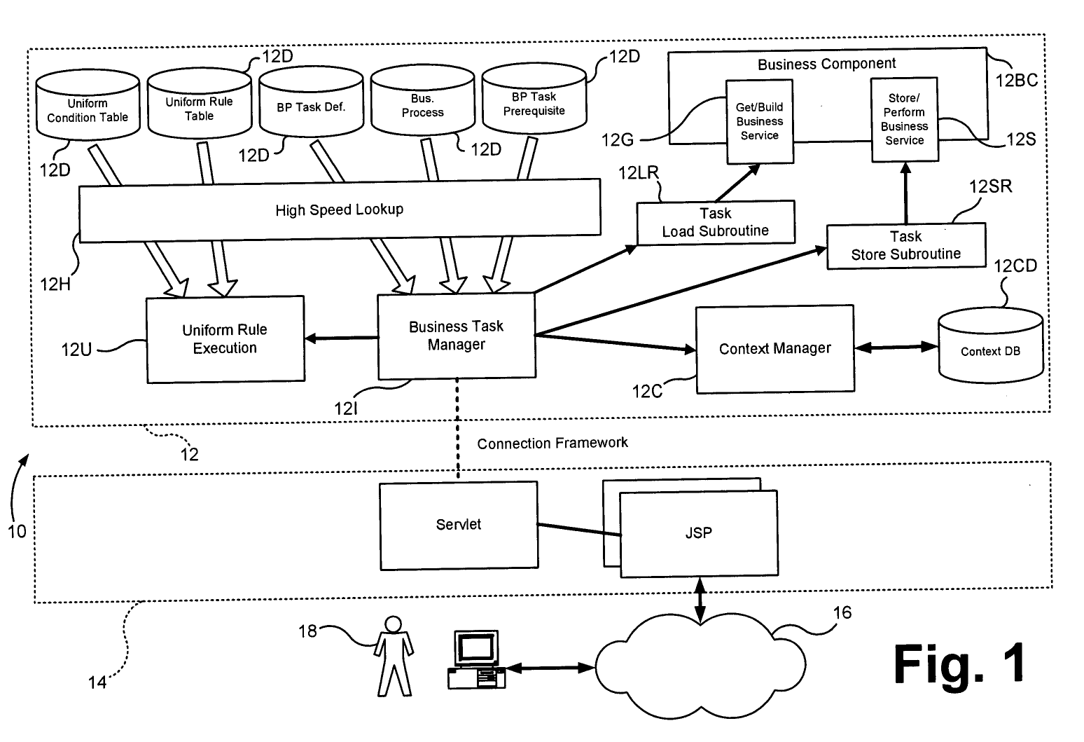

Referring to FIG. 1, the present invention comprises a task management system (10). In one embodiment, the task management system of the present invention comprises a business tier (12) and a presentation tier (14). The business tier of the present invention provides a business task manager interface (12I) designed to control business process flow utilizing at least one business component (12BC) and one or more storage devices (12D) containing externalized process flow rules and/or definitions.

In one embodiment, a uniform rule execution module (12U) is coupled to the business task manager interface (12I) in order to facilitate the execution of externalized process flow rules retrieved from the storage device(s) (12D). It being understood that externalized process flow rules may be directly retrieved by the business task manager interface and/or the uniform rule execution module via a known high speed look-up device (12H).

In one embodiment, the business component (12BC) of the present invention comprises a get/build business service module (12G) and a store/perform business service module (12S). The get/build business service module may be accessed by the business task manager interface via a task load subroutine (12LR) while the store/perform business service module may be accessed via a task store subroutine (12SR). In one embodiment, the present invention utilizes a series of software driven subroutines designed to facilitate interaction between the business task manager interface (12I), various modules provided by the system, and the user (18).

In one embodiment, the present invention provides a context manager (12C) designed to facilitate communication between the business task management interface (12I) and the context database (12CD). In one embodiment, the business task manager interface uses the context manager to persist intermediate information about each business process into the context database. For each task, this may include the condition, i.e., ready or not ready, and status, i.e., complete or incomplete. One task may set a value that another task's flow rules utilize, this may also require saving such information into the context database. If a task requires the capability to temporarily save information while a user interface is presented to the user, the contextual database may save such information until another task is executed.

As referenced above, the present invention provides a presentation tier (14) designed to interact with one or more users. Specifically, by accessing a URL address through a computer network (16), such as the internet, the user may be granted access to the unique capabilities of the present invention. In one embodiment, security infrastructure is utilized to provide security to the system against unauthorized access and/or harmful viruses. In one embodiment, a firewall (not shown) positioned between the presentation tier (14) and the computer network (16) is utilized for this purpose. In one embodiment, the presentation tier (14) is connected to the business tier (12) via a connection framework. Through the connection framework, the presentation tier receives “ready to present” information provided by the business task manger interface (12I). As illustrated in FIG. 1, interaction with the user may be facilitated by java servlets and/or JAVA server pages (JSP). In one embodiment, web server and application server technology such as a server farm of Intel Pentium 4/MS Windows servers running Apache Http Server on Linux operating systems and IBM midrange servers running Websphere Application Server or BEA's Weblogic Server on AIX operating systems may be utilized by the presentation server to facilitate user interaction. It being understood that this is an illustrative example only and that any number of hardware configurations may be utilized.

The use of externalized rules allows for dramatic flexibility during business process execution, creation, and maintenance. For example, changes no longer have to be made to the business processes themselves, only to the externalized rules held upon one or more external databases (12D). As described above, this is accomplished via the business task manager interface (12I) which acts as a “gatekeeper” between the business component and the externalized process flow rules. In short, the use of externalized rules instead of hard-coding into each business process allows each task to be amended quickly and easily through changes to the software comprising the rules. This feature of the present invention also allows each task to be independent and reusable for more than one business process.

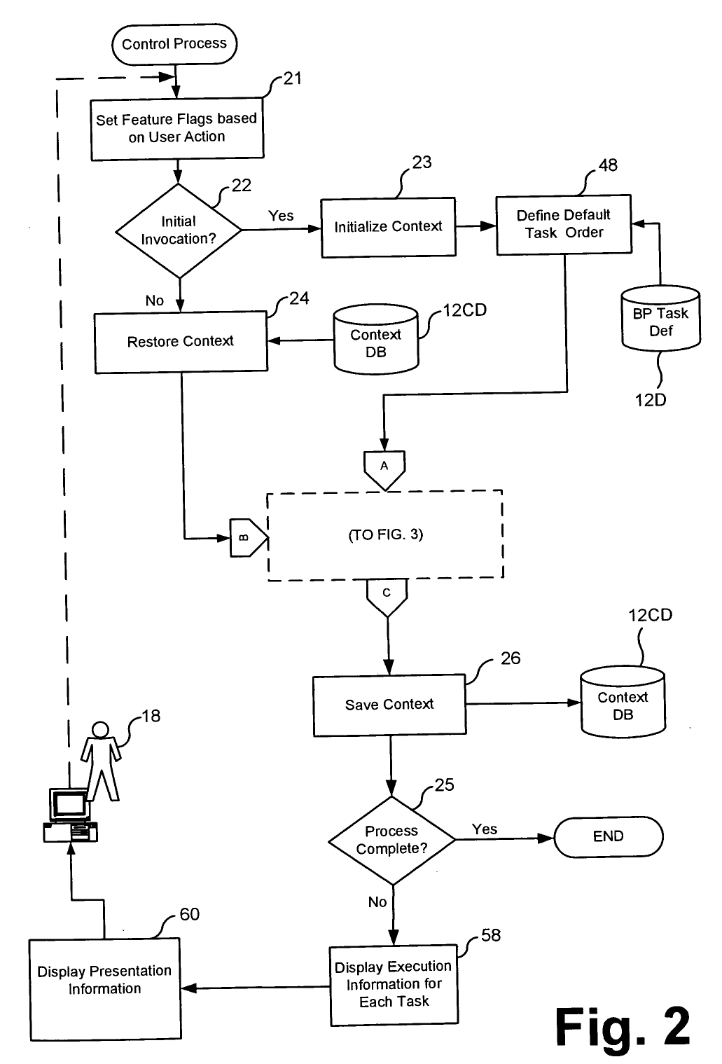

Referring to FIG. 2, the business task manager of the present invention provides a control process for use with each business process. In one embodiment, user actions are utilized to set one or more feature flags for use during process flow rule execution, as illustrated by Box 21. For example, if the UI provided to the user offers “next”, “abort” and “previous” control buttons, the system may assign feature flags based upon each potential user action. These flags may then be used to define, redefine, and/or alter the present invention's control.

Once feature flags have been set, the present invention determines whether it has dealt with the particular user and business process before, as illustrated by Box 22. If it has not previously initialized, it initializes stored contextual data, i.e., made ready to the applicable process flow rules, such that a default task execution order may be defined, as illustrated by Boxes 23 and 48.

In one embodiment, the default order assigned by the present invention is designed to present presentation information to the user in an efficient manner so as to encourage the user to provide additional data required to fulfill the purpose of the business process. For example, in providing an insurance quote, the rules may provide that driver information should be obtained prior to vehicle information.

In one embodiment, the externalized process flow rules provide a task execution hierarchy representing a stored task definition table. Once a task execution hierarchy has been defined by the externalized process flow rules, additional rules may be provided in order to 1) alter the order in which tasks are to be executed and 2) re-define one or more tasks associated with the business process.

In one embodiment, the present invention utilizes contextual data received from one or more sources to alter and/or redefine the task execution process, as described further below. Once the task execution hierarchy has been established, the present invention determines which tasks will be executed. In one embodiment, the present invention provides a user interface for use in displaying graphical and/or textual information to the user (18).

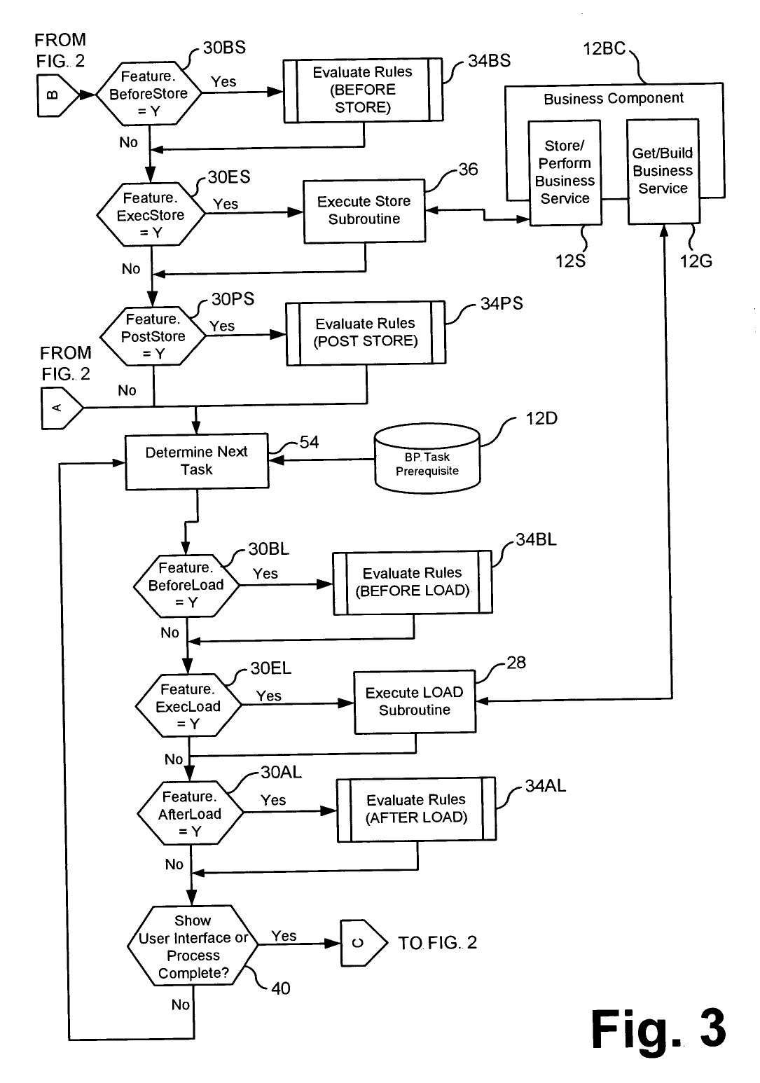

For those situations where there has already been a previous initial invocation, the system restores contextual data previously stored upon the context database (12CD), as illustrated by Box 24. This feature of the present invention allows for convenient contextual data acquisition regardless of the status of the business process at issue. After contextual data has been captured, the business task manager executes a series of process flow rules and/or subroutines related to each individual task relating to the business process. This process is illustrated in detail in FIG. 3, and is discussed further below.

Once each task has been completed according to FIG. 3, contextual data received during execution is stored and the process is ended if no more tasks remain for execution, as illustrated by Boxes 26 and 25. In one embodiment, contextual data is stored upon the context database (12CD).

In addition to determining the status of each task for any given business process, the present invention may also provide for the static and/or dynamic alteration of one or more individual tasks. In one embodiment, externalized process flow rules are designed to define a set of tasks required to execute one or more electronic business processes. Each task is then associated with stored presentation information. In this context, presentation information comprises any electronic data having a purpose in performing the business process at issue. In one embodiment, presentation information would include data for presentation upon a user interface including files, pictures, data entry fields, links, etc. Presentation information and task execution information are displayed to the user (18) via the UI, as illustrated by Boxes 58 and 60. As described above, information entered by the user may be utilized to set feature flags and/or dynamically alter the manner in which information is processed/presented.

Referring to FIG. 3, after the presentation information and user interface, if applicable, have been displayed, the system executes BEFORESTORE rules designed to determine if a STORE subroutine should be initiated, as illustrated by Boxes 30BS and 34BS. If the STORE subroutine is determined to be necessary, the STORE subroutine is executed and the results are provided to the business component (12BC), as illustrated by Boxes 30ES and 36. The STORE subroutine may utilize the business component (12BC) to validate and/or store business data. In one embodiment, such data is stored upon the store/perform business service module (12S) of the business component.

POSTSTORE externalized flow rules may then be executed, as illustrated by Boxes 30PS and 34PS. The POSTSTORE rules typically specify other tasks which may be inserted dynamically based upon contextual data received from external sources including the user, as discussed further below. After execution of the POSTSTORE rules, the system determines which task will be executed next, as illustrated by Box 54. If another task, or an amended task is required, the new task's status is determined and the load process is initiated.

In one embodiment, the present invention maintains the status associated with each task. When determining the next task (54), if the task is not marked as READY for execution, the system will access the BP Task Prerequisite Table (12D) for the task's prerequisites. If each of the prerequisite tasks are COMPLETE, the system marks the task as READY and uses it as the next task to execute. In this manner, the present invention provides active management of each task, and in doing so, ensures that only those tasks which are ready for execution are available to the user (18).

The task which is selected for execution (54) is then executed. The present invention executes the BEFORELOAD rules, as illustrated by Boxes 30BL and 34BL. In one embodiment, the BEFORELOAD rules provide guidance as to where electronic data necessary for task execution is located. Once the BEFORELOAD rules have been executed, the system may execute the LOAD subroutine, which invokes the business component (12BC) in order to retrieve presentation information, as illustrated by Boxes 30EL and 28. In one embodiment, presentation information is drawn from the get/build business services component (12G) of the business component (12BC).

Once the LOAD subroutine has been executed the AFTERLOAD rules are executed, as illustrated by Boxes 30AL and 34AL In one embodiment, the AFTERLOAD rules contain process flow rules for deciding which user interface and/or alternate task will be utilized. For example, in a vehicle insurance process, a driver-list user interface may be loaded in order to execute a driver information retrieval task. However, if no drivers have been defined, the system may assume that the named insured is to be added as the first driver and, as a result, the system may automatically execute an alternate task.

If a user interface is associated with the task at issue, the present invention displays the appropriate user interface, as illustrated by Boxes 40, 58 and 60. In one embodiment, electronic information relating the user interface to be displayed is drawn from the get/build business services module (12G) of the business component (12BC). If the task does not have a UI, the system automatically determines which task to execute next, as illustrated by Box 54. This may be accomplished through utilization of the default task order or an altered/amended execution arrangement as required by contextual data.

As illustrated by FIG. 3, feature flags may be utilized to determine which rules and/or subroutines require execution. For example, in one embodiment, if the user presses an “abort” control button, the system will set each feature flag, illustrated by Boxes 30BS, 30ES, 30PS, 30BL, 30EL, and 30AL, to “NO” such that none of the rules/subroutines will be executed subsequent to the user's “abort” entry. This feature of the present invention allows the system to adapt individual U's to the needs of each user by monitoring and responding to user actions, i.e., matching each user input to the controls of the present invention.

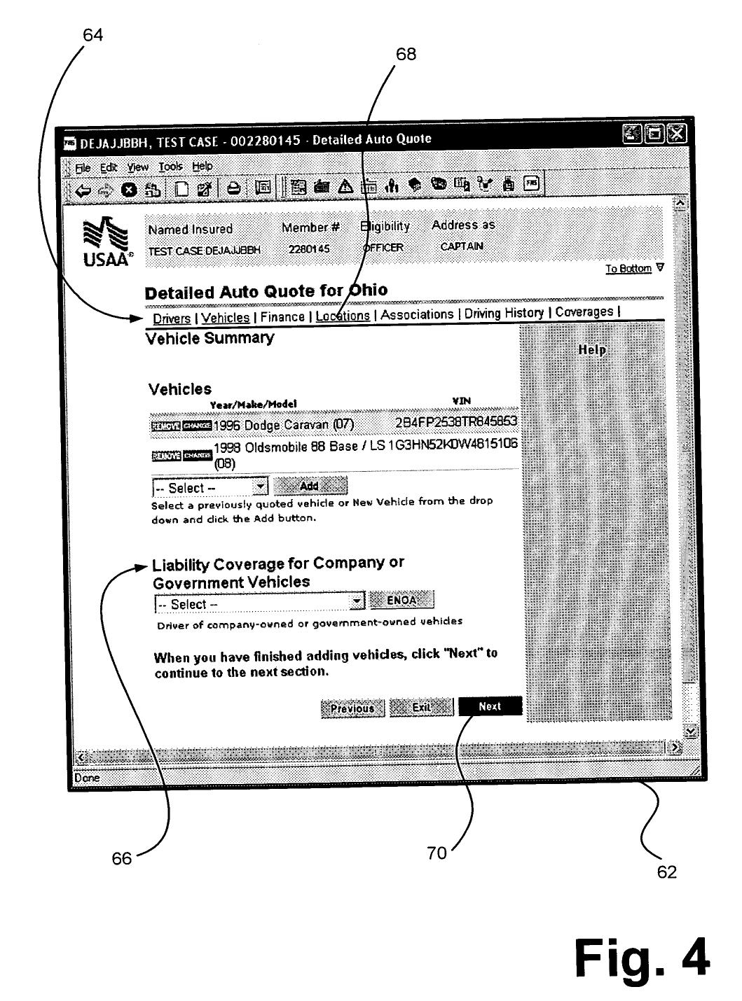

Referring to FIG. 4, presentation information and task execution information may be displayed upon separate user interfaces or upon the same user interface in order to provide the user with multiple information sets at the same time. For example, in an insurance environment, the present invention may display instructions, data entry fields, and other fields related to the entry and evaluation of vehicle insurance. This information may be supplemented and/or augmented with information relating to particular tasks associated with the vehicle insurance business process.

In one embodiment, task execution information capable of supplementing and/or augmenting presentation information may comprise one or more status indicators relating to one or more tasks associated with the business process. In the above example, a number of different tasks may be required in order to provide a vehicle insurance quote including a driver information task, a vehicle information task, a risk assessment task, etc. As such, the present invention is capable of identifying the relative status of each task associated with the business process through the use of graphic and/or textural indicators including, but not limited to, color variations, text variations, highlighting, underlining, etc. This feature of the present invention informs the user of other tasks associated with the business process as well as their relative status.

In one embodiment, the present invention provides a taskbar for displaying and providing task execution functionality to the user. As described above, the taskbar of the present invention may be displayed simultaneously or separately from the presentation information provided to the user. FIG. 4 illustrates a user interface (62) capable of providing both presentation information (66) and task execution information (68) through use of an integrated taskbar (64). In one embodiment, the user interface of the present invention is equipped with one or more control buttons (70) through which the user may manipulate task execution. In one embodiment, the user interface of the present invention provides both passive and active control functionality. For example, if the user desires to proceed according to the default order provided by the system, a “next” button is provided in order to allow the user to passively proceed from one task to another. However, the user interface may also provide active functionality to allow the user to proceed according to a non-default ordering scheme. In one embodiment, such functionality is provided by the taskbar. To illustrate, FIG. 4 shows a taskbar having a task listing, including drivers, vehicles, finance, locations, associations, driving history, and coverages. It should be noted that this example is for illustration only and that a taskbar and/or user interface may be equipped with a wide variety of task identifiers and their corresponding status indicators, depending on the particular business application.

In the above example, drivers, vehicles, and locations are highlighted and equipped with linking functionality. In this manner, the user is informed that 1) the drivers, vehicles, and locations tasks are ready to execute and may be displayed for execution upon the user clicking its associated link. Note also that the other remaining illustrative task titles of the example UI, i.e., finance, associations, etc., are not highlighted and do not have linking functionality. In this example, tasks without linking functionality are not ready for execution. Thus, they are not currently accessible by the user. This feature of the present invention allows the user to be informed as to the status of each task and proceed through the “ready” tasks at his or her discretion.

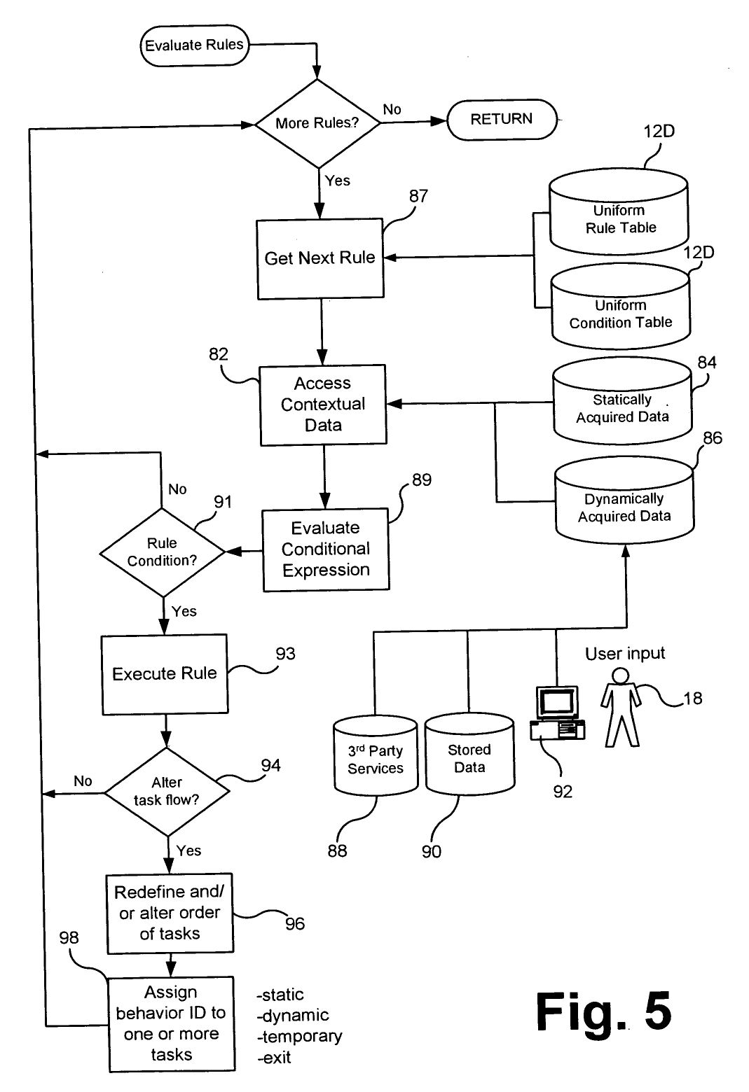

Referring to FIG. 5, the present invention is capable of altering the default order of tasks execution and/or redefining one or more tasks as directed by contextual data. In one embodiment, contextual data may include any information useful in executing any given task and/or business process. In the above example, contextual data may take the form of information required to execute various insurance related tasks and/or business processes including information such as Motor Vehicle Reports (MVR), driving records, accident reports, etc.

The process flow rules of the present invention are designed to determine when contextual data will be acquired such that it is only acquired when necessary. In this manner, the present invention greatly reduces the costs associated with acquiring and maintaining contextual data. As illustrated by Boxes 82 and 87, the present invention determines whether contextual data will be acquired prior to and during execution of each task. In one embodiment, the process flow rules are designed to 1) provide a reference to contextual data that might be required 2) determine whether the contextual data is currently available to the process flow rule, and 3) determine from what sources contextual data may be obtained, should it become necessary.

In some instances, it is cost effective to maintain contextual data and make it available to its associated process flow rule. When such a determination has been made, the contextual data is retrieved prior to execution of the task and, as such, is statically acquired. However, in cases where it is not cost effective to maintain voluminous contextual data, the present invention provides for dynamic acquisition of contextual data during task execution. In this manner, contextual data may be acquired from 1) the user through the user interface, and/or 2) other sources including one or more storage devices and/or information provided by third parties, as illustrated by Boxes 82, 84, 86, 88, and 90. Further, the process flow rules may determine that the user (18) should be prompted for additional information in order to satisfy a requirement for contextual data, as illustrated by Box 92. In this manner, the present invention utilizes all available information in order to provide the user with the highest quality product and/or service available. In one embodiment, once contextual data has been acquired by the system, conditional expressions associated with the contextual data may be evaluated to determine if one or more applicable rule conditions are satisfied, as illustrated by Boxes 89, 91, and 93.

The present invention may utilize contextual data to alter the task execution flow, as illustrated by Box 94. In one embodiment, such alterations may include redefining one or more tasks associated with the business process at issue. In this context, redefining one or more tasks may involve adding and/or deleting one or more tasks from the original set of tasks determined to be necessary for the business process. Further, contextual data may be utilized to alter the default order in which the tasks are to be executed, as illustrated by Box 96. In this way, the present invention allows for unparalleled flexibility and efficiency.

In one embodiment of the present invention, a behavior identifier may be assigned to one or more tasks, as illustrated by Box 98. The behavior identifier may be utilized to specify the character of the task. In one embodiment, a “static” behavior identifier may be applied to tasks which already exist within the original task execution hierarchy defined by the process flow rules. In contrast, a dynamically inserted and/or acquired task may be assigned a “dynamic” behavior identifier in order to illustrate its “dynamic” nature relative to the original business process.

Secondary behavior identifiers may also be utilized for “dynamic” tasks in order to specify the manner in which each task is to be deleted, if at all. For example, in one embodiment, a “temporary” behavior identifier may be assigned to a dynamically inserted task which is to be deleted when the task is no longer current. Further, an “exit” behavior identifier may be assigned to a dynamically inserted task that is to be removed from the parent task once the parent task has completed execution. In this manner, the present invention insures that subsequent tasks are not overburdened with “stale” tasks that are no longer necessary.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

We claim:

1. A method of managing the operation of one or more electronic business processes comprising the steps of:
providing a plurality of externalized process flow rules for:
defining a set of tasks required to execute said business process;
associating stored presentation information with each task;
defining a task execution hierarchy providing a default order in which said tasks are to be executed;
altering said default order in which said tasks are to be executed as directed by contextual data received from one or more sources; and
re-defining one or more of said tasks as directed by said contextual data.

2. The method of claim 1, further comprising the additional step of assigning a behavior identifier to at least one of said tasks.

3. The method of claim 2, wherein said behavior identifier is selected from the group consisting of static, dynamic, temporary and exit.

4. The method of claim 1, wherein said contextual data comprises stored electronic data and/or electronic data received through a user interface.

5. The method of claim 4, wherein said process flow rules are for determining when said contextual data will be acquired from said one or more sources.

6. The method of claim 4, wherein said user interface further comprises a first user interface for displaying presentation information relating to each task.

7. The method of claim 6, wherein said user interface further comprises a second user interface for displaying task execution information.

8. The method of claim 1, wherein said task execution hierarchy comprises a task definition table.

9. The method of claim 7, wherein said task execution information comprises one or more status identifiers relating to each task.

10. The method of claim 7, wherein said second interface comprises a taskbar for displaying a list of tasks required to execute said business process.

11. The method of claim 6, wherein said first interface further provides one or more electronic control buttons through which the user may manipulate task execution.

12. The method of claim 1, wherein at least one of said tasks are re-useable across more than one of said business processes.

13. The method of claim 5, wherein said contextual data is dynamically acquired.

14. The method of claim 5, wherein said contextual data is statically acquired.

15. A method of managing the operation of one or more electronic business processes comprising the steps of:
providing a plurality of externalized process flow rules for:
defining a set of tasks required to execute said business process;
associating stored presentation information with each task;
defining a task execution hierarchy providing a default order in which said tasks are to be executed;
altering said default order in which said tasks are to be executed as directed by contextual data received from one or more sources;
re-defining one or more of said tasks as directed by said contextual data; and
providing a user interface comprising a first user interface for displaying presentation information relating to each task and a second user interface for displaying task execution information.

16. The method of claim 15, wherein said task execution hierarchy comprises a task definition table.

17. The method of claim 15, wherein said task execution information comprises one or more status identifiers relating to each task.

18. The method of claim 15, wherein said first interface further provides one or more electronic control buttons through which the user may manipulate task execution.

19. The method of claim 15, further comprising the additional step of assigning a behavior identifier to at least one of said tasks.

20. The method of claim 19, wherein said behavior identifier is selected from the group consisting of static, dynamic, temporary and exit.

21. The method of claim 15, wherein said contextual data comprises stored electronic data and/or electronic data received through said user interface.

22. The method of claim 21, wherein said process flow rules are for determining when said contextual data will be acquired from said one or more sources.

23. The method of claim 22, wherein said contextual data is dynamically acquired.

24. The method of claim 22, wherein said contextual data is statically acquired.
